(19) United States
(12) Patent Application Publication
(10) Pub. No.: US 2014/0123020 A1
(43) Pub. Date: May 1, 2014

(54) MULTIPLE USER INTERFACE PLATFORM SUPPORT FOR PORTAL APPLICATIONS

(71) Applicants: Orly Bleier, Hod Hasharon (IL); Rachel Ebner, Ra'anana (IL); Gadi Melamed, Givat Shmuel (IL)

(72) Inventors: Orly Bleier, Hod Hasharon (IL); Rachel Ebner, Ra'anana (IL); Gadi Melamed, Givat Shmuel (IL)

(73) Assignee: SAP AG

(21) Appl. No.: 13/660,698

(22) Filed: Oct. 25, 2012

(51) Int. Cl. G06F 3/01

(52) U.S. Cl. 715/746

(57) ABSTRACT

The disclosure generally describes methods, media, and systems for providing multiple user interface platform technology support for portal applications. One computer-implemented method includes receiving, using a user-interface (UI) framework of a computing system including one or more computers, a request for incremental data from a specified application of at least one application, wherein, prior to receipt of the request, UI platform code formatted according to a particular UI platform technology type was transmitted to a requestor of the request, parsing the request to determine at least the specified application, determining whether the specified application includes a UI platform handler, determining a responsive UI platform technology type, and determining whether to switch the particular UI platform technology type to the responsive UI platform technology type.

### BACKGROUND

Modern web-enabled client computing devices often support multiple types of user interface (UI) technologies and/or capabilities (collectively, UI platform technologies). For example, the client may use an HTML-compliant web browser, ADOBE FLEX, MICROSOFT SILVERLIGHT as well HTML5, ADOBE FLASH, and CSS 3 UI capabilities associated with one or more of the UI technologies. Current enterprise portals allow multiple client types to interface with the enterprise portal, but often support a very limited number of UI platform technologies. This is due to the need to support at least duplicate applicative business logic and persistence for each UI platform technology type. This necessary support is financially and technologically resource intensive, often resulting in a business organization purposely limiting UI platform support for an portal application. As a result, usability of the portal application is unduly limited and portal application developers are required to reduce and/or prohibit what would otherwise be available functionality for the portal application. The unavailable functionality often results in a less robust, coherent, and/or secure browsing experience for enterprise portal users. Efficiency of portal application development and maintenance can also be affected by the inability to leverage possibly more efficient UI platform technologies when available. This inefficiency may lead to a higher total cost of ownership for the enterprise portal.

### SUMMARY

The present disclosure relates to methods, media, and systems for providing multiple user interface platform technology support for portal applications. One computer-implemented method includes receiving, using a user-interface (UI) framework of a computing system including one or more computers, a request for incremental data from a specified application of at least one application, wherein, prior to receipt of the request, UI platform code formatted according to a particular UI platform technology type was transmitted to a requestor of the request, parsing the request to determine at least the specified application, determining whether the specified application includes a UI platform handler, determining a responsive UI platform technology type, and determining whether to switch the particular UI platform technology type to the responsive UI platform technology type.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features:

In a first aspect, combinable with the general implementation, the request includes a requested UI platform technology type with which to format a response to the request.

In a second aspect, combinable with any of the previous aspects, if the specified application includes the UI platform handler, the specified application determines the responsive UI platform technology type for a response to the request, and if the specified application does not include the UI platform handler, the UI framework determines the responsive UI platform technology type for the response to the request.

In a third aspect, combinable with any of the previous aspects, the UI framework overrides a determination of the responsive UI platform technology type by the specified application.

A fourth aspect, combinable with any of the previous aspects, further comprising: generating incremental data corresponding to the particular UI platform technology type; and transmitting the generated incremental data as part of a response to the request.

A fifth aspect, combinable with any of the previous aspects, further comprising: loading UI platform client code corresponding to the responsive UI platform technology type, generating portal application data associated with the loaded UI platform client code, and transmitting the loaded UI platform code and generated portal application data in response to the request.

A sixth aspect, combinable with any of the previous aspects, further comprising generating a response instructing the requestor of the request to refresh the requestor of the request's UI in accordance with the responsive UI platform technology type.

The subject matter described in this specification can be implemented in particular implementations so as to realize one or more of the following advantages. First, additional user interface (UI) technologies and/or capabilities (UI platform technology) are made available for use by portal applications. Second, a portal user's experience is enhanced by a greater range of UI platform technologies associated with the portal applications. The additionally available UI platform technologies may provide a more robust, coherent, and/or secure portal application experience to the portal user. Third, the portal application functionality can be enhanced for greater consistency and/or made more efficient due to the availability of the additional UI platform technologies. Fourth, enhanced portal application functionality with respect to multiple client types and supported UI platform technologies may provide a marketing advantage for a particular portal application. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for providing multiple user interface platform technology support for portal applications.

FIG. 2 is a block diagram illustrating additional detail of components of the example distributed computing system for providing multiple user interface platform technology support for portal applications.

FIG. 3 is a flow chart of an example method for performing an initial application load.

FIG. 4 is a flow chart of an example method for switching a user interface platform with an incremental data request resulting in a new request that loads the new user interface platform.

FIG. 5 is a flow chart of an example method for switching a user interface platform with a an incremental data request resulting in a user interface platform switch without the need for a new request.

Like reference numbers and designations in the various drawings indicate like elements.

### DETAILED DESCRIPTION

The disclosure generally describes computer-implemented methods, computer-readable media, and systems for providing multiple user interface platform technology support for portal applications.

For the purposes of this disclosure, an enterprise portal (EP) is a framework for integrating information, people, and processes across system and organizational boundaries and offers a single point of access to information, portal applications, and services both inside and outside an organization. An EP provides a secure unified access point, often in the form of a graphical user interface (GUI), such as a web browser, using various user interface (UI) technologies and/or capabilities (collectively, UI platform technologies). The EP is designed to aggregate and personalize information through application-specific portals. The EP is a de-centralized content contribution and content management system, which keeps the information always updated. With the GUI, EP users can begin work once they have been authenticated in the EP. EPs may present information from diverse sources on mobile or other client devices in a unified and structured way, and provide additional services, such as dashboards, an internal search engine, e-mail, news, navigation tools, and various other features. EPs are often used by enterprises for providing their employees, customers, and possibly additional users with a consistent look-and-feel, access control, and procedures for multiple applications, which otherwise would have been separate entities altogether.

Modern web-enabled client computing devices often support multiple UI platform technologies. For example, the client may use an HTML-compliant web browser, ADOBE FLEX, MICROSOFT SILVERLIGHT as well HTML5, ADOBE FLASH, and CSS 3 UI capabilities associated with one or more of the UI technologies. Current EPs allow multiple client types to interface with the EP, but often support a very limited number of UI platform technologies. This is due to the need to support at least duplicate applicative business logic and persistence for each UI platform technology type. This necessary support is financially and technologically resource intensive, often resulting in a business organization purposely limiting UI platform support for a portal application. As a result, usability of the portal application is unduly limited and portal application developers are required to reduce and/or prohibit what would otherwise be available functionality for the portal application. The unavailable functionality often results in a less robust, coherent, and/or secure browsing experience for EP users. Efficiency of portal application development and maintenance can also be affected by the inability to leverage possibly more efficient UI platform technologies when available. What is needed is a way to dynamically provide, for a particular portal application's application logic, UI platform code for one or more UI platform technologies. The dynamically provided UI platform code is generated “on the fly” in response to requests made by particular client portal application implementations, a client-side application programming interface (AP)I framework, a server-side UI framework, and/or the portal application.

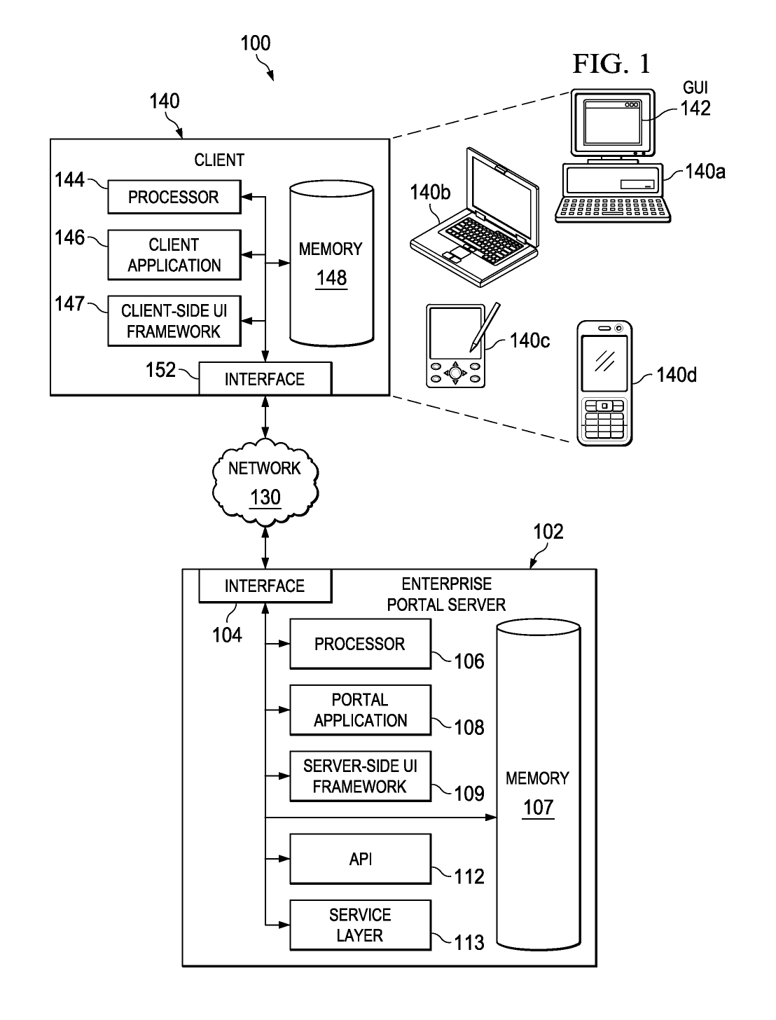

FIG. 1 is a block diagram illustrating an example distributed computing system 100 for providing multiple user interface platform technology support for portal applications. The illustrated example distributed computing system 100 includes or is communicably coupled with an enterprise portal server (EPS) 102 and a client 140 that communicate across a network 130.

At a high level, the EPS server 102 is an electronic computing device operable to receive, transmit, process, store, or manage data and information associated with the example distributed computing system 100. Generally, the EPS server 102 allows users to view, compose, modify, delete, and deploy EP pages. According to one implementation, EPS 102 may also include or be communicably coupled with an e-mail server, a web server, a caching server, a streaming data server, and/or other suitable server. Specifically, the described computer-implemented methods, computer-readable media, and systems provide functionality for providing multiple user interface platform technology support for portal applications within the example distributed computing system 100.

The EPS 102 is responsible for receiving portal application requests, for example navigation and/or information requests, from one or more client applications 146 associated with the client 140, and responding to the received requests by processing said requests using at least the associated portal application 108 and sending an appropriate response from the portal application 108 back to the requesting client application 146. In addition to requests from the client 140, requests associated with the portal application 108 may also be sent from internal users, external or third-party customers, other applications, as well as any other appropriate entities, individuals, systems, or computers.

The EPS 102 may contain at least a portal application 108 and a server-side UI framework 109, where at least a portion of the portal application 108 and the server-side UI framework 109 is executed using requests/responses sent from/to a client 140. In some implementations, requests/responses can be sent directly to EPS 102 from a user accessing EPS 102 directly. In some implementations, the EPS 102 may store a plurality of various portal applications 108 and/or server-side UI frameworks. In some implementations, one or more of the components of EPS 102 can represent web-based applications accessed and executed by the client 140 using the network 130 or directly at the EPS 102 to perform the programmed tasks or operations of the various components of EPS 102.

In some implementations, any and/or all of components of the EPS 102, both hardware and/or software, may interface with each other and/or the interface using an application programming interface (API) 112 and/or a service layer 113. The API 112 may include specifications for routines, data structures, and object classes. The API 112 may be either computer language independent or dependent and refer to a complete interface, a single function, or even a set of APIs. The service layer 113 provides software services to the example distributed computing system 100. The functionality of the EPS 102 may be accessible for all service consumers using this service layer. Software services, such as provide reusable, defined business functionalities through a defined interface. For example, the interface may be software written in JAVA, C++, or other suitable language providing data in extensible markup language (XML) format or other suitable format.

While illustrated as an integrated component of the EPS 102 in the example distributed computing system 100, alternative implementations may illustrate the API 112 and/or service layer 113 as a stand-alone component in relation to other components of the example distributed computing system 100. Moreover, any or all parts of the API 112 and/or service layer 113 may be implemented as child or sub-modules of another software module, portal application, or hardware module without departing from the scope of this disclosure.

The EPS 102 includes an interface 104. Although illustrated as a single interface 104 in FIG. 1, two or more interfaces 104 may be used according to particular needs, desires, or particular implementations of the example distributed computing system 100. The interface 104 is used by the EPS 102 for communicating with other systems, for example the client 140, in the example distributed computing system using the network 130 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The EPS 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the EPS 102. Specifically, the processor 106 executes the functionality required to provide multiple user interface platform technology support for portal applications.

The EPS 102 also includes a memory 107 that holds data for the EPS 102 and associated EPS 102 components. Although illustrated as a single memory 107 in FIG. 1, two or more memories may be used according to particular needs, desires, or particular implementations of the example distributed computing system 100. While memory 107 is illustrated as an integral component of the EPS 102, in alternative implementations, memory 107 can be external to the EPS 102 and/or the example distributed computing system 100. In some implementations, the memory 107, i.e., the content repository for the EPS 102 that holds the description and/or data for all objects and/or data, for example, a business processes associated with a portal application 108 and associated business process data (not illustrated).

The portal application 108 is generally a web-based application, but may also be any other type of application permitting a client 140 to request, view, edit, and/or delete content related to the portal application 108. In some implementations, the portal application 108 is a web-based application deployed/hosted on a web server, such as EPS 102, and presented in a web browser. In some implementations, the portal application 108 is one in which all or some portion of the portal application 108 software is downloaded from a web, such as the Internet or local area network (LAN), each time it is run. Although illustrated as a single portal application 108 in FIG. 1, two or more portal applications 108 may be available on the same EPS 102 according to particular needs, desires, or particular implementations of the example distributed computing system 100.

A particular portal application 108 may operate in response to and in connection with at least one request received from other portal applications 108, including a portal application 108 associated with another EPS 102. In some implementations, each portal application 108 can represent a network-based application accessed and executed using the network 130 (e.g., through the Internet, or using at least one cloud-based service associated with the portal application 108). In some implementations, the portal application 108 can be wholly or partially a service. For example, a portion of a particular portal application 108 may be a web service associated with the portal application 108 that is remotely called, while another portion of the portal application 108 may be an interface object or agent bundled for processing at a remote client 140. Moreover, any or all of a particular portal application 108 may be a child or sub-module of another software module or portal application (not illustrated) without departing from the scope of this disclosure. Still further, portions of the particular portal application 108 may be executed or accessed by a user working directly at the EPS 102, as well as remotely at a corresponding client 140.

The server-side UI framework 109 is a framework generally used to provide, among other things, a common interface for one or more components of EPS 102 to access various features, functionalities, and/or data associated with one or more components of the example distributed computing system 100 and/or a common interface for components of the example distributed computing system 100 to access various features, functionalities, and/or data associated with one or more components of EPS 102. The server-side UI framework 109 also provides decision logic to decide which UI platform should be displayed by a client 140, decision logic to switch an existing client 140 UI platform to a different UI platform, priority management logic to manage priority of UI platform requests and/or decisions, and/or other suitable functions consistent with this disclosure and as described below. In some implementations, the server-side UI framework 109 provides pre-defined API software method/function libraries to provide various functionalities consistent with the description above. In some implementations, the portal application 108 interfaces with the server-side UI framework 109. In this implementation, the server-side UI framework 109 acts as a relay for all inbound/outbound communications between the portal application 108 and/or other components of the example distributed computing system 100. For example, the server-side UI framework 109 can relay messages, files, data, data structures, parameters, status information, flags, and the like between the portal application 108 and the client application 146 executing on client 140.

The illustrated example distributed computing system 100 also includes a client 140. The client 140 may be any computing device operable to connect to or communicate with at least the EPS 102 using the network 130. In general, the client 140 comprises an electronic computer device operable to receive, transmit, process, and store any appropriate data associated with the example distributed computing system 100.

The illustrated client 140 includes a client application 146. A particular client application may be any type of software application, for example a web browser, that allows a user to request, view, process, and/or manage content associated with the EPS 102 and/or the client 140 on the client 140. Client application 146 is generally made up of both presentation logic, for example the UI platform handler, and business logic (not illustrated). The UI platform handler 212 (described in more detail below) performs tasks necessary to determine a proper UI platform technology type to display the data on the screen, for example through GUI 142. The business logic generally performs data entry, updating, querying, reporting, and/or other suitable task for the client application 146. Once a particular client application 146 is launched, a user may interactively process a task, event, or other information associated with the portal application 108 executing on EPS 102. In some implementations, the client application 146 can further receive, use, display, modify, and/or perform other suitable functions on content, parameters, metadata, and/or other information received from and/or associated with the EPS 102, the client 140, and/or other component of the example distributed computing system 100 with or apart from the user. Although illustrated as a single client application 146, the client application 146 may be implemented as multiple client applications in the client 140.

The client 140 further includes a client-side UI framework 147. The client-side UI framework 147 is generally used to provide, among other things, a common interface for one or more components of client 140 to access various features, functionalities, and/or data associated with one or more components of the example distributed computing system 100, a common interface for components of the example distributed computing system 100 to access various features, functionalities, and/or data associated with one or more components of client 140, one or more decisions as to which UI platform should be displayed by a client 140, one or more decisions to switch an existing client 140 UI platform to a different UI platform, priority management of UI platform requests and/or decisions, and/or other suitable functions consistent with this disclosure and as described below. In some implementations, the client-side UI framework 147 provides pre-defined API software method/function libraries to provide various functionalities consistent with the description above. In some implementations, the client application 146 interfaces with the client-side UI framework 147. In this implementation, the client-side UI framework 147 acts as a relay for all inbound/outbound communications between the client application 146 and/or other components of the example distributed computing system 100. For example, the client-side UI framework 147 can relay messages, files, data, data structures, parameters, status information, flags, and the like between client application 146 and the portal application 108 executing on the EPS 102. The client-side UI framework 147 may be implemented in ADOBE FLEX, MICROSOFT SILVERLIGHT, HTML5, Javascript, and/or other suitable UI technology.

Further, the illustrated client 140 includes a GUI 142. In general, the GUI 142 generates a visual representation of generated content and provides interactive functionality for a client 140 user. The generated content may originate with one or more components of the client 140 and/or other components of the example distributed computing system 100. More specifically, the GUI 142 displays content generated by the portal application 108 in, for example, a client application 146. The GUI 142 also provides interactive functionally with the client application 146 and/or a portal application 108. For example, the GUI 142, as an integral part of the client application 146, may be used to view, input, navigate, and/or delete data/content associated with various portal pages generated by the portal application 108.

The illustrated client 140 further includes an interface 152, a processor 144, and a memory 148. The interface 152 may be consistent with or different from the above-mentioned interface 104 of the EPS 102 and may be used by the client 140 for communicating with other computing systems in the example distributed computing environment 100 using the network 130. The processor 144 may be consistent with or different from the above-described processor 106 of the EPS 102 and specifically executes instructions and manipulates data to perform the operations for the client 140, including the functionality required to send/receive requests/responses to/from the EPS 102. The memory 148 may be consistent with or different from one or more of the above-described memories of the EPS 102 but storing objects and/or data associated with the purposes of the client 140.

There may be any number of clients 140 associated with, or external to, the example distributed computing system 100. For example, while the illustrated example distributed computing system 100 includes one client 140 communicably coupled to the EPS 102, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the EPS 102 on the client 140 itself, including digital data, visual information, audio information, and/or other suitable information.

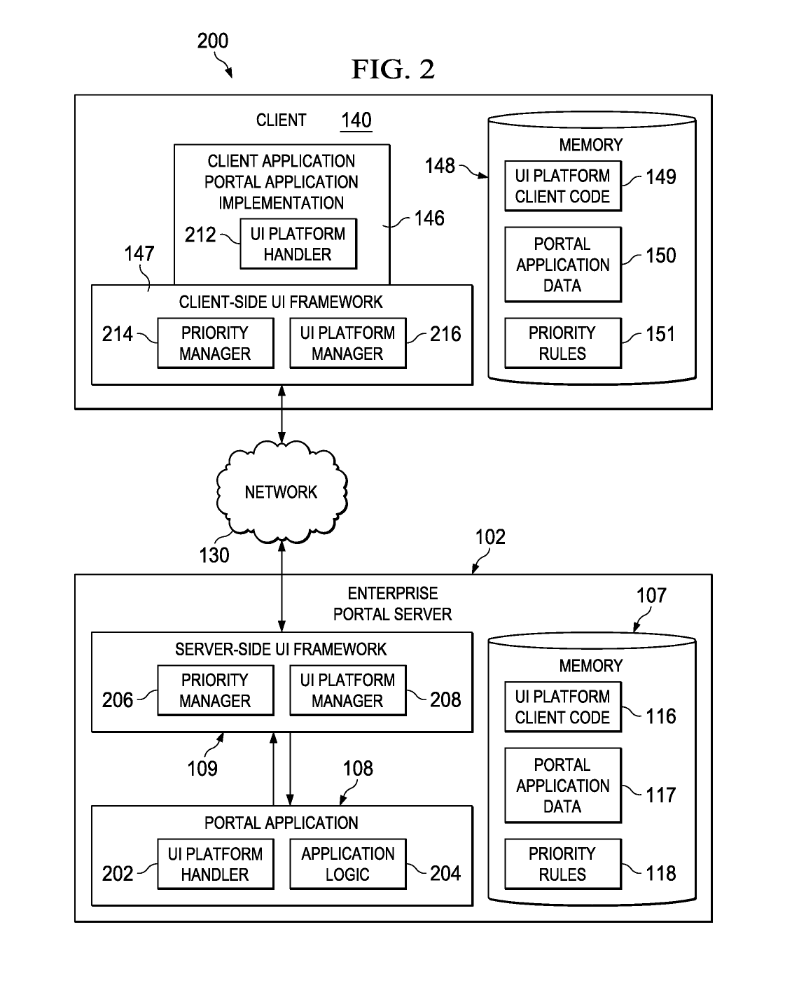

Turning now to FIG. 2, FIG. 2 is a block diagram illustrating additional detail of components of the example distributed computing system for providing multiple user interface platform technology support for portal applications.

In some implementations, the EPS 102 memory 107 can hold one or more instances of UI platform client code 116, portal application data 117, and/or priority rules 118. While the one or more instances of the UI platform client code 116, the portal application data 117, and/or the priority rules 118 are illustrated as an integral to the memory 107 in alternative implementations, they can be external to the memory 107 and/or the example distributed computing system 100 as long as accessible to at least memory 107 through, for example, a pointer or other type of reference.

The EPS 102 UI platform client code 116 represents one or more instances of portal application 108 code to execute on a client 140. In some implementations, the UI platform client code 116 for each particular UI platform technology type is generated by a portal application developer and stored in memory 107. The generated UI platform client code 116 for a particular UI platform technology type is then loaded by the portal application 108 UI platform handler 202 in accordance with a determined particular UI platform technology type. For example, if it is requested/determined that the UI platform for the client 140 should be considered HTML executing an ADOBE FLASH plugin, an appropriate instance of the UI platform client code 116 would be loaded by the UI platform handler 202 to execute in an HTML-compliant browser using an ADOBE FLASH plugin, for example the client application 146, and then transmitted to the client 140. In some implementations, the generated UI platform client code 116 can be transmitted directly to the client 140 and used by the client application 146. In other implementations, the UI platform client code 116 can be transmitted to the client 140 and stored in a memory, for example, memory 148, prior to use. The client application 146 can then access and/or render the stored UI platform client code 149 in, for example, GUI 142. For example, the client application 146 may receive/access UI platform client code 116/149 for a table of retail customers from the portal application 108 and then render the UI platform client code 116/149 as a table of retail customers in a web browser, for example client application 146.

In some implementations, the UI platform client code 116 can be encrypted, compressed, and/or otherwise pre-processed by one or more components of EPS 102 prior to transmission to the client 140. In some implementations, the received/stored UI platform client code 116/149 is also post-processed by one or more components of the client 140 prior to use. For example, if the UI platform client code 116 is received by the client 140 in a compressed/encrypted state, the client 140 may decompress and/or decrypt the received UI platform client code 116 before storing the UI platform client code 116 into memory 148 as UI platform client code 149. In some implementations, the UI platform client code 116 is not stored in memory 107 and is, instead, transferred to client 140.

The portal application data 117 represents one or more instances of data associated with one or more instances of portal application UI platform client code 116 loaded in accordance with a particular UI platform or as values returned in response to a request for an incremental data update not resulting in a change to an existing UI platform. For example, portal application data 117 may be business data that is received and/or retrieved from various backend servers, such as a customer relation management (CRM) system or other suitable system. In the example provided above with respect to the UI platform client code 116 table of retail customers, the rendered table of retail customers could be populated by the client application 146 with portal application data 117 also transmitted to the client 140 either with or separately from the UI platform client code 116. In some implementations, the generated portal application data 117 can be transmitted directly to the client 140 and used and/or stored as one or more instances in a memory, for example, memory 148, prior to use. For example, the client application 146 can receive/access portal application data 117/151 to render it in, for example, GUI 142, as part of the above mentioned rendered table of retail customers. In some implementations, the portal application data 117 is not stored in memory 107 and is, instead, transferred to client 140.

Priority rules 118 may represent policies, conditions, parameters, variables, algorithms, instructions, constraints, references, and any other appropriate information used by the priority manager 206 of the server-side UI framework 109 to determine which UI platform type should be displayed by a client 140 and associated with various purposes of the EPS 102. Generally, a request for a specific UI platform technology type received from the client application 146 UI platform handler 212 or the client-side UI framework 147 UI platform manager 214 is given priority over any UI platform technology type determinations made by components of the EPS 102. In other implementations, the priority rules 118 may optionally alter the priority and give higher weight to decisions made by components of the EPS 102 under either certain conditions or for all conditions. In some implementations, the priority rules 118 may be manually updated and/or dynamically updated by the priority manager 206 based upon user input and/or data generated or calculations performed by one or more components of the example distributed computing system 100.

Priority rules 151 represent policies, conditions, parameters, variables, algorithms, instructions, constraints, references, and any other appropriate information used by the priority manager 216 of the client-side UI framework 147 to optionally determine which UI platform technology type should be displayed by a client 140 and associated with the various purposes of the client 140. In some implementations, priority rules 151 can be consistent with the above-mentioned priority rules 118 but associated with the particular purposes of the client 140. In some implementations, priority rules 118 and/or priority rules 151 can be transferred between the EPS 102 and the client 140 and used by associated priority managers 206/214 to perform determinations associated with EPS 102 and/or client 140. In some implementations, the EPS 102 priority rules 118 can be accessed by the client 140 and the client 140 priority rules 151 can be accessed by the EPS 102. In some implementations, the priority rules 118 are not stored in memory 107 and are, instead, transferred to client 140 where they are accessed by priority manager 206 and/or priority manager 214.

As illustrated, the portal application 108 contains both application logic 204 and a UI platform handler 202. The UI platform handler 202 handles presentation logic functions for the portal application 108, specifically tasks necessary for display of data on a GUI, for example GUI 142. More specifically, the UI platform handler 202 is one or more routines/algorithms responsible for determining, for the portal application 108, an appropriate UI platform technology type for a particular client 140. In some implementations, the UI platform handler 202 can load particular UI platform client code 116 and/or portal application data 117 associated with the determined UI platform technology type. In still other implementations, the loaded particular UI platform client code 116 and/or the portal application data 117 can be stored in memory 107 and/or transferred to the client 140 by the UI platform handler 202 for processing and/or display.

In some implementations, the UI platform handler 202 is optional. In these implementations, UI platform technology type decisions may be made by either a UI platform manager 208 (described below), a UI platform handler 212 (described below), and/or a UI platform manager 216 (described below). In some implementations, the UI platform handler 202 can be wholly or partially a service.

In some implementations, the UI platform handler 202 is plugged in to the server-side UI framework 109, for example as a plug-in invoked by the UI platform manager 208. In some implementations, the UI platform handler 202 may have one or more particular routines/algorithms, i.e., handlers, each handler handling a particular UI platform technology type for the UI platform handler 202.

The application logic 204 handles required data processing for the portal application 108. Specifically, the data processing is performed by one or more routines/algorithms that handle data entry, updating, querying, reporting, and/or other suitable task for the portal application 108. In some implementations, the application logic 204 can use various policies, conditions, parameters, variables, instructions, constraints, references, and/or any other appropriate information necessary to perform tasks associated with the portal application 108. In some implementations, the UI platform handler can be wholly or partially a service.

As illustrated, the server-side UI framework 109 contains both a priority manager 206 and a UI platform manager 208. The priority manager 206 uses the priority rules 118 and/or priority rules 151 to provide request priority management for UI platform technology types. Specifically, the priority management is performed by one or more routines/algorithms that process one or more of the priority rules 118, priority rules 151, EPS 102 environmental factors (e.g., network bandwidth, processing capability, data types requested, and the like), EPS 102 user input, client 140 type and capabilities, and other suitable factors to manage UI platform technology type decisions made by one or more of the UI platform manager 208, the UI platform handler 202, and/or client 140. For example, if a request for a particular UI platform technology type is received from the client 140, and the UI platform manager 208 makes a contrary decision as to which UI platform technology type should be displayed by the client 140, the priority manager 206 mediates and decides which UI platform technology type takes priority. In some implementations, the priority manager 206 can override a previous decision due to manually and/or dynamically changing factors as discussed above. For example, if a client 140 user installs the ADOBE FLASH browser plug-in on the client 140, the client 140 client-side UI framework 147 (described below) may notify the EPS 102 and the priority manager 206 may adjust a prior, current, and/or future decision. In some implementations, the priority manager 206 can also update the priority rules 118 and/or the priority rules 151. In some implementations, the priority manager 206 can be wholly or partially a service.

The UI platform manager 208 is one or more routines/algorithms responsible for determining, as a part of the server-side UI framework 109, an appropriate UI platform technology type for a particular client 140/client application 146 and generating particular UI platform client code 116 and/or portal application data 117 associated with the determined UI platform technology type. In some implementations, the loaded UI platform client code 116 and/or the portal application data 117 is stored in memory 107 and/or transferred to the client 140 by the UI platform manager 208 for processing and/or display. In some implementations, the UI platform manager 208 can be wholly or partially a service. In some implementations, the UI platform manager is plugged in to the server-side UI framework 109, for example as a plug-in. In some implementations, similar to the UI platform handler 202, the UI platform manager 208 may have one or more particular routines/algorithms, i.e., handlers, each handler handling a particular UI platform technology type for the UI platform manager 208. In some implementations, the UI platform manager 208 analyzes factors particular to EPS 102, for example, EPS 102 environmental factors (e.g., installed software, network bandwidth, processing capability, data types requested, and the like), client 140 user input, client 140 type and capabilities, and other suitable factors make a decision as to the appropriate UI platform technology type for the client 140 with respect to client application 146.

The client application 146 contains a UI platform handler 212. The UI platform handler 212 is part of the client application 146 and handles presentation logic functions for the client application 146, specifically tasks necessary for display of data on a GUI, for example GUI 142. More specifically, the UI platform handler 212 is one or more routines/algorithms responsible for determining, for the client application 146, an appropriate UI platform technology type to use to display the client application on the client 140. The UI platform handler 212 is loaded together with the client application 146. In some implementations, the UI platform handler 212 is an abstract API with a set of defined methods. The client application 146 declares that the UI platform handler 212 is supported and implements the methods provided by the UI platform handler 212. The client-side UI framework 147 detects if the client application 146 implemented the UI platform hander 212 and, if so, invokes the defined methods associated with the UI platform handler 212. In some implementations, the UI platform handler 212 can be wholly or partially a service. In some implementations, the UI platform handler 212 is plugged in to the server-side UI framework 109, for example as a plug-in.

In some implementations, the UI platform handler 212 can include in a request for an initial application load and/or an incremental data request, a request for a particular UI platform technology type. For example, a client application 146 could request that application code/data returned responsive to a request for an initial application load from the portal application 108 conform to HTML 5 standards. In this example, the UI platform handler 212 would ensure that the particular UI platform technology was included in the request to the portal application 108.

In some implementations, the UI platform handler 212 is optional. In these implementations, UI platform technology type decisions may be made by the UI platform manager 208, the UI platform handler 202, and/or a UI platform manager 216 (described below). In some implementations, the UI platform handler 212 may have one or more particular routines/algorithms, i.e., handlers, each handler handling a particular UI platform technology type for the UI platform handler 212.

As illustrated, the client-side UI framework 147 contains both a priority manager 214 and a UI platform manager 216. The priority manager 214 uses the priority rules 151 and/or priority rules 118 to provide request priority management for UI platform technology types. Specifically, the priority management is performed by one or more routines/algorithms that process one or more of the priority rules 151, priority rules 118, client 140 environmental factors (e.g., network bandwidth, processing capability, data types requested, and the like), client 140 user input, client 140 type and capabilities, and other suitable factors to manage UI platform technology type decisions made by the UI platform manager 216 and/or client 140. For example, if a request for a particular UI platform technology type is received at the client-side UI framework 147 from the client 140, and the UI platform manager 216 makes a contrary decision as to which UI platform technology type should be displayed by the client 140, the priority manager 214 mediates and decides which UI platform technology type takes priority. In some implementations, the priority manager 214 can override a prior, current, and/or future decision due to manually and/or dynamically changing factors as discussed above. For example, if a client 140 user installs the ADOBE FLASH browser plug-in on the client 140 and if the client application 146 then requests an initial portal application 108 load using HTML and SILVERLIGHT, the UI platform manager 216 may decide that HTML and ADOBE FLASH is a more efficient UI platform technology type to request from the EPS 102 for the initial application load from portal application 108. In this instance, the priority manager 214 may then overrule the client application 146 UI platform handler 212 and modify the received request before forwarding the request to the EPS 102. In some implementations, the priority manager 214 can also update the priority rules 151 and/or the priority rules 118. In some implementations, the priority manager 214 can be wholly or partially a service.

The UI platform manager 216 is one or more routines/algorithms responsible for determining, as a part of the client-side UI framework 147, an appropriate UI platform technology type for a particular client 140/client application 146. In some implementations, the UI platform manager 216 can be wholly or partially a service. In some implementations, the UI platform manager 216 is plugged in to the client-side UI framework 147, for example as a plug-in. In some implementations, similar to the UI platform manager 208, the UI platform manager 216 may have one or more particular routines/algorithms, i.e., handlers, each handler handling a particular UI platform technology type for the UI platform manager 216. In some implementations, the UI platform manager 216 analyzes factors particular to client 140, for example, client 140 environmental factors (e.g., installed software, network bandwidth, processing capability, data types requested, and the like), and other suitable factors to make a decision as to the appropriate UI platform technology type for the client 140 with respect to client application 146.

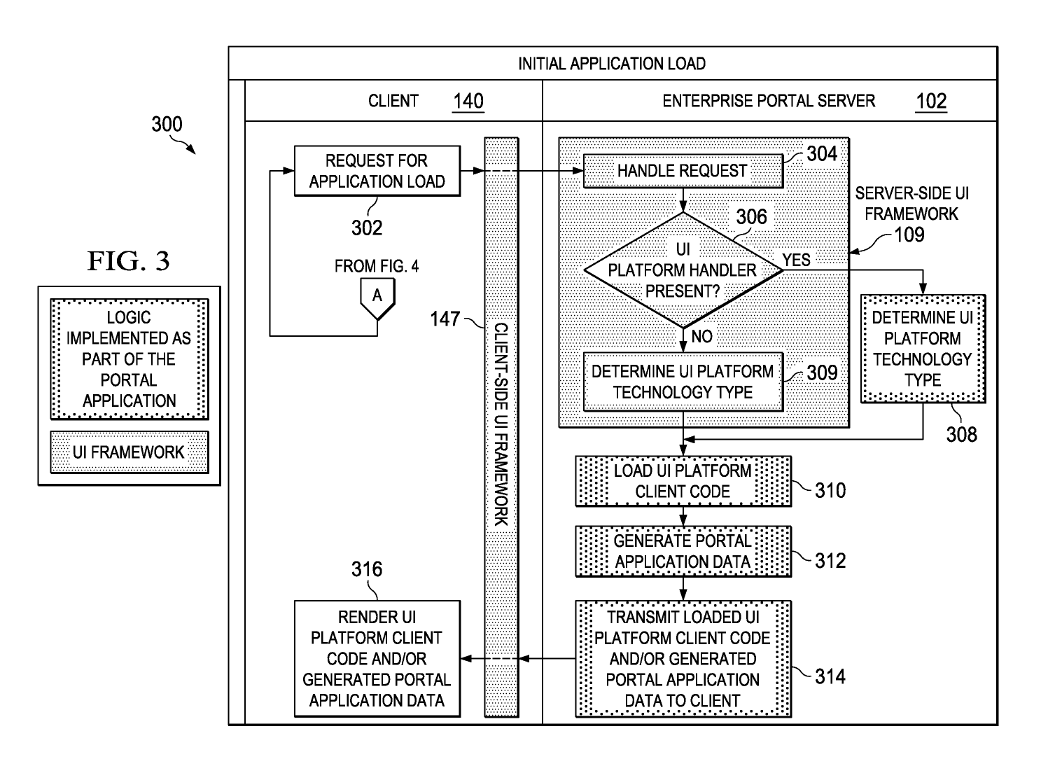

Turning now to FIG. 3, FIG. 3 is a flow chart of an example method 300 for performing an initial application load. For clarity of presentation, the description that follows generally describes method 300 in the context of FIGS. 1 and 2. However, it will be understood that method 300 may be performed, for example, by any other suitable system, environment, software, and hardware, or a combination of systems, environments, software, and hardware as appropriate.

At 302, a request for an initial application load is made by the client application. For example, a client user has opened up a web browser and initiated a request, such as typing in a URL, to navigate to a portal application on an enterprise portal server. In some implementations, the request is made by the client application using the UI platform handler. In some implementations, the initiated request may contain data for a specific requested UI platform technology type. In some implementations, the request is sent directly to the enterprise portal server by the client application while, in other implementations, the request is received by the client-side UI framework and relayed to the enterprise portal server. From 302, method 300 proceeds to 304.

At 304, the request received by the server-side UI framework is handled. In some implementations, the received request is wholly or partially handled by a generic server request handler (not illustrated) interfaced with the server-side UI framework. In other implementations, the received request is wholly or partially handled by one or more components of the server-side UI framework. In some implementations, the request handling results in a received request that is split, transformed, and/or suitably processed in some other manner. From 304, method 300 proceeds to 306.

At 306, a determination is made whether the requested portal application has an associated UI platform handler. If at 306, it is determined that the requested portal application has an associated UI platform handler, method 300 proceeds to 308. However, if at 306, it is determined that the requested portal application does not have an associated UI platform handler, method 300 proceeds to 309 In some implementations, the UI platform manager wholly or partially performs the determination. In other implementations, the priority manager wholly or partially performs the determination.

At 308, the UI platform handler associated with the requested portal application determines which UI platform technology type the client should display. In some implementations, the priority manager and/or the UI platform manager associated with the server-side UI framework can override the determination made by the UI platform handler associated with the requested portal application. From 308, method 300 proceeds to 310.

At 309, the UI platform manager associated with the server-side UI framework determines which UI platform technology type the client should display. If the request received from the client and handled at 304 contains data for a specific requested UI platform technology type, the UI platform manager takes this into consideration in making a determination. In most implementations, a particular UI platform technology type request made by the client-side UI platform handler and passed with the request received by the server-side UI framework will supersede UI platform technology type decisions made by one or more components of the enterprise portal server. In still other implementations, one or more of the client-side priority manager, UI platform manager, and/or UI platform handler can override a received UI platform technology type request from the client. From 309, method 300 proceeds to 310.

At 310, the portal application loads, if applicable, UI platform client code for the portal application corresponding to the previously determined UI platform technology type. In some implementations, the UI platform client code is stored into memory. From 310, method 300 proceeds to 312.

At 312, the portal application generates, if applicable, portal application data in an appropriate format associated with the UI platform client code for the portal application corresponding to the previously determined UI platform technology type. In some implementations, base data used to generate the portal application data is requested and/or received from other components of the example distributed computing environment 100 or other systems (not illustrated). In some implementations, the generated portal application data is stored into memory. In some implementations, the application logic and/or UI platform handler of the portal application wholly or partially generates the portal application data. In other implementations, the server-side UI framework UI platform manager and/or priority manager wholly or partially generates the portal application data. From 312, method 300 proceeds to 314.

At 314, the loaded UI platform client code and/or generated portal application data is transmitted to the client by way of the client-side UI framework. From 314, method 300 proceeds to 316.

At 316, the client-received UI platform client code and/or generated portal application data is rendered by the client on a GUI. After 316, method 300 stops.

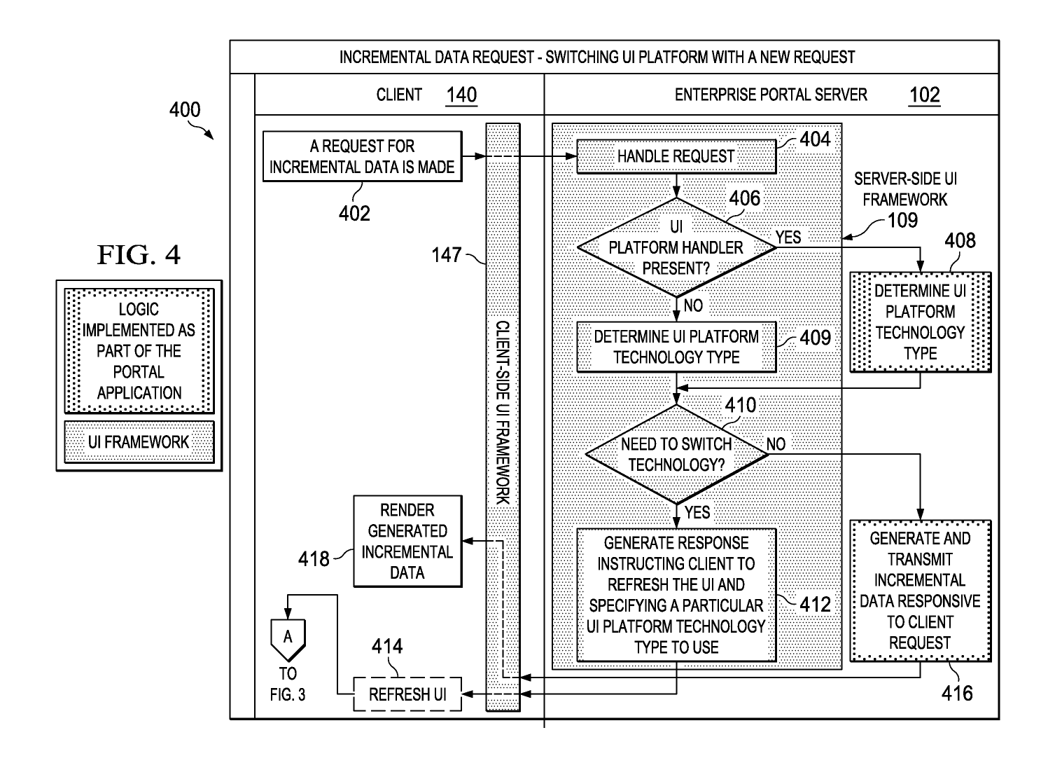

Turning now to FIG. 4, FIG. 4 is a flow chart of an example method 400 for switching a user interface platform with an incremental data request resulting in a new request that loads the new user interface platform. For clarity of presentation, the description that follows generally describes method 400 in the context of FIGS. 1, 2, and 3. However, it will be understood that method 400 may be performed, for example, by any other suitable system, environment, software, and hardware, or a combination of systems, environments, software, and hardware as appropriate.

At 402, a request for incremental data is made by the client and received by the client-side UI framework. For example, a client user who has already navigated to a portal application and is viewing a table of retail customers initiates a request for incremental data related to a retail customer by selecting the displayed retail customer. In some implementations, the initiated request may contain data for a specific requested UI platform technology type. The client-side UI framework relays the request to the server-side UI framework. In some implementations, the client-side UI framework (UI platform manager and/or priority manager) can override the request for a specific requested UI platform technology type. From 402, method 400 proceeds to 404.

At 404, the request received by the server-side UI framework is handled. In some implementations, the received request is wholly or partially handled by a generic server request handler (not illustrated) interfaced with the server-side UI framework. In other implementations, the received request is wholly or partially handled by one or more components of the server-side UI framework. In some implementations, the request handling results in a received request that is split, transformed, and/or suitably processed in some other manner. From 304, method 300 proceeds to 306.

At 406, a determination is made whether the requested portal application has an associated UI platform handler. If at 406, it is determined that the requested portal application has an associated UI platform handler, method 400 proceeds to 408. However, if at 406, it is determined that the requested portal application does not have an associated UI platform handler, method 400 proceeds to 409 In some implementations, the UI platform manager wholly or partially performs the determination. In other implementations, the priority manager wholly or partially performs the determination.

At 408, the UI platform handler associated with the requested portal application determines which UI platform technology type the client should display. In some implementations, the priority manager and/or the UI platform manager associated with the server-side UI framework can override the determination made by the UI platform handler associated with the requested portal application. From 408, method 400 proceeds to 410.

At 409, the UI platform manager associated with the server-side UI framework determines which UI platform technology type the client should display. If the request received from the client and handled at 404 contains data for a specific requested UI platform technology type, the UI platform manager takes this into consideration in making a determination. In most implementations, a particular UI platform technology type request made by the client-side UI platform handler and passed with the request received by the server-side UI framework will supersede UI platform technology type decisions made by one or more components of the enterprise portal server. In still other implementations, one or more of the client-side priority manager, UI platform manager, and/or UI platform handler can override a received UI platform technology type request from the client. From 409, method 400 proceeds to 410

At 410, a determination is made whether an existing UI platform technology type in use by the client needs to be switched based upon the determination of a UI platform technology type. For example, the client may be using a UI platform technology type and the received request for incremental data makes the request to a different portal application to supply the incremental data, where the different portal application does not support the existing UI platform technology type. In another example, if the incremental data requires the use of a different UI platform technology type to be properly rendered, it may be determined that a switch is necessary. As will be appreciated by those skilled in the art, various criteria consistent with this disclosure may be used to determine the need to switch to an alternate UI platform technology type. If at 410, it is determined that the existing UI platform technology type needs to be switched, method 400 proceeds to 412. However, if at 410, it is determined that the existing UI platform technology type does not need to be switched, method 400 proceeds to 416. In some implementations, the UI platform manager wholly or partially performs the determination. In other implementations, the priority manager wholly or partially performs the determination.

At 412, a response to the request for incremental data instructing the requesting client to refresh its UI according to the determined UI platform technology type is generated and transmitted to the client. In some implementations, the server-side UI framework UI platform manager wholly or partially generates and/or transmits the response. From 412, method 400 proceeds to 414.

At 414, the client refreshes its UI in accordance with the determined UI platform technology type. From 414, method 400 proceeds to FIG. 3.

At 416, a response containing generated incremental data response to the client request is generated and transmitted by the portal application to the client by way of the client-side UI framework. In some implementations, the application logic of the portal application wholly or partially generates the response. In other implementations, the portal application UI application handler wholly or partially generates the response. From 416, method 400 proceeds to 418.

At 418, the client renders the received generated incremental data in accordance with the existing UI platform technology type. After, 414, method 400 stops.

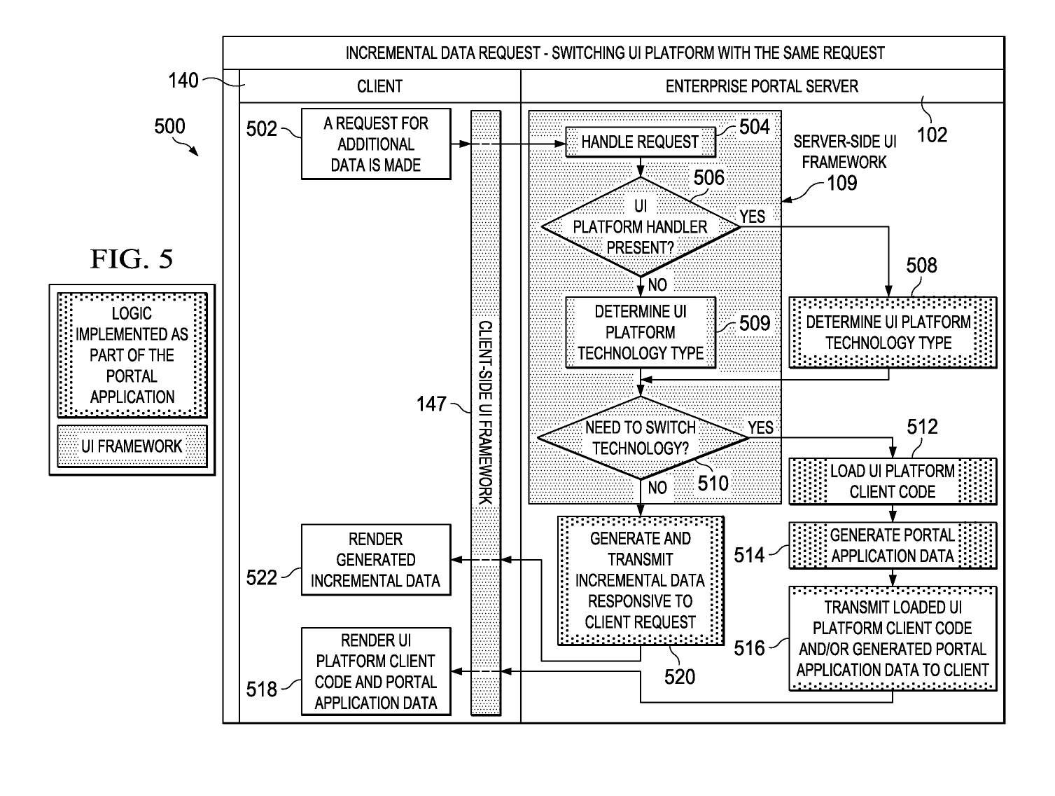

Turning now to FIG. 5, FIG. 5 is a flow chart of an example method 500 for switching a user interface platform with a an incremental data request resulting in a user interface platform switch without the need for a new request. For clarity of presentation, the description that follows generally describes method 500 in the context of FIGS. 1, 2, 3, and 4. However, it will be understood that method 500 may be performed, for example, by any other suitable system, environment, software, and hardware, or a combination of systems, environments, software, and hardware as appropriate.

502 to 510 are consistent with the above-described 402-410. If at 510, it is determined that the existing UI platform technology type needs to be switched, method 500 proceeds to 512. However, if at 510, it is determined that the existing UI platform technology type does not need to be switched, method 500 proceeds to 520. In some implementations, the UI platform manager wholly or partially performs the determination. In other implementations, the priority manager wholly or partially performs the determination.

At 512, the portal application loads, if applicable, UI platform client code for the portal application corresponding to the previously determined UI platform technology type. In some implementations, the UI platform client code is stored into memory. From 512, method 500 proceeds to 514.

At 514, the portal application generates, if applicable, portal application data associated with the loaded UI platform client code for the portal application corresponding to the previously determined UI platform technology type. In some implementations, base data used to generate the portal application data is requested and/or received from other components of the example distributed computing environment 100 or other systems (not illustrated). In some implementations, the portal application data is stored into memory. In some implementations, the application logic and/or UI platform handler of the portal application wholly or partially generates the portal application data. In other implementations, the server-side UI framework UI platform manager and/or priority manager wholly or partially generates the portal application data. From 514, method 500 proceeds to 516.

At 516, the loaded UI platform client code and/or generated portal application data is transmitted to the client by way of the client-side UI framework. From 516, method 500 proceeds to 518.

At 518, the client-received UI platform client code and/or generated portal application data is rendered by the client on a GUI. After 518, method 500 stops.

At 520, a response containing generated incremental data response to the client request is generated and transmitted by the portal application to the client by way of the client-side UI framework. In some implementations, the application logic of the portal application wholly or partially generates the response. In other implementations, the portal application UI application handler wholly or partially generates the response. From 520, method 500 proceeds to 522.

At 522, the client renders the received generated incremental data in accordance with the existing UI platform technology type. After, 522, method 500 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Memory and/or computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, portal application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving, using a user-interface (UI) framework of a computing system including one or more computers, a request for incremental data from a specified application of at least one application, wherein, prior to receipt of the request, UI platform code formatted according to a particular UI platform technology type was transmitted to a requestor of the request;
parsing the request to determine at least the specified application;
determining whether the specified application includes a UI platform handler;
determining a responsive UI platform technology type; and
determining, by operation of a computer, whether to switch the particular UI platform technology type to the responsive UI platform technology type.

2. The method of claim 1, wherein the request includes a requested UI platform technology type with which to format a response to the request.

3. The method of claim 1, wherein:
if the specified application includes the UI platform handler, the specified application determines the responsive UI platform technology type for a response to the request; and
if the specified application does not include the UI platform handler, the UI framework determines the responsive UI platform technology type for the response to the request.

4. The method of claim 3, wherein the UI framework overrides a determination of the responsive UI platform technology type by the specified application.

5. The method of claim 1, further comprising:
generating incremental data corresponding to the particular UI platform technology type; and
transmitting the generated incremental data as part of a response to the request.

6. The method of claim 1, further comprising:
loading UI platform client code corresponding to the responsive UI platform technology type;
generating portal application data associated with the loaded UI platform client code; and
transmitting the loaded UI platform code and generated portal application data in response to the request.

7. The method of claim 1, further comprising generating a response instructing the requestor of the request to refresh the requestor of the request's UI in accordance with the responsive UI platform technology type.

8. A non-transitory, computer-readable medium storing computer-readable instructions executable by a data processing apparatus and operable to:
receive, using a user-interface (UI) framework, a request for incremental data from a specified application of at least one application, wherein, prior to receipt of the request, UI platform code formatted according to a particular UI platform technology type was transmitted to a requestor of the request;
parse the request to determine at least the specified application;
determine whether the specified application includes a UI platform handler;
determine a responsive UI platform technology type; and
determine whether to switch the particular UI platform technology type to the responsive UI platform technology type.

9. The medium of claim 8, wherein the request includes a requested UI platform technology type with which to format a response to the request.

10. The medium of claim 8, wherein:
if the specified application includes the UI platform handler, the specified application determines the responsive UI platform technology type for a response to the request; and
if the specified application does not include the UI platform handler, the UI framework determines the responsive UI platform technology type for the response to the request.

11. The medium of claim 10, wherein the UI framework overrides a determination of the responsive UI platform technology type by the specified application.

12. The medium of claim 8, further operable to:
generate incremental data corresponding to the particular UI platform technology type; and
transmit the generated incremental data as part of a response to the request.

13. The medium of claim 8, further operable to:
load UI platform client code corresponding to the responsive UI platform technology type;
generate portal application data associated with the loaded UI platform client code; and
transmit the loaded UI platform code and generated portal application data in response to the request.

14. The medium of claim 8, further operable to generate a response instructing the requestor of the request to refresh the requestor of the request's UI in accordance with the responsive UI platform technology type.

15. A system, comprising:
at least one computer configured to:
receive, using a user-interface (UI) framework, a request for incremental data from a specified application of at least one application, wherein, prior to receipt of the request, UI platform code formatted according to a particular UI platform technology type was transmitted to a requestor of the request;
parse the request to determine at least the specified application;
determine whether the specified application includes a UI platform handler;
determine a responsive UI platform technology type; and
determine whether to switch the particular UI platform technology type to the responsive UI platform technology type.

16. The system of claim 15, wherein the request includes a requested UI platform technology type with which to format a response to the request.

17. The system of claim 15, wherein:
if the specified application includes the UI platform handler, the specified application determines the responsive UI platform technology type for a response to the request; and
if the specified application does not include the UI platform handler, the UI framework determines the responsive UI platform technology type for the response to the request.

18. The system of claim 17, wherein the UI framework overrides a determination of the responsive UI platform technology type by the specified application.

19. The system of claim 15, further configured to:
generate incremental data corresponding to the particular UI platform technology type; and
transmit the generated incremental data as part of a response to the request.

20. The system of claim 15, further configured to:
load UI platform client code corresponding to the responsive UI platform technology type;
generate portal application data associated with the loaded UI platform client code; and
transmit the loaded UI platform code and generated portal application data in response to the request.

21. The system of claim 15, further configured to generate a response instructing the requestor of the request to refresh the requestor of the request's UI in accordance with the responsive UI platform technology type.
